(19) United States
(12) Patent Application Publication
(10) Pub. No.: US 2015/0089297 A1
(43) Pub. Date: Mar. 26, 2015

(54) Using Crowd Experiences for Software Problem Determination and Resolution

(71) Applicant: International Business Machines Corporation, Armonk, NY (US)

(72) Inventors: Conrad J. Johnson, Pflugerville, TX (US); Andrew J. Lavery, Austin, TX (US); James M. Pavlovsky, Cedar Park, TX (US); Lorin E. Ullmann, Austin, TX (US); Bruce R. Underwood, Austin, TX (US)

(73) Assignee: International Business Machines Corporation, Armonk, NY (US)

(21) Appl. No.: 14/037,018

(22) Filed: Sep. 25, 2013

(51) Int. Cl. G06F 11/36

(52) U.S. Cl. CPC G06F 11/3672
USPC 714/38.1

(57) ABSTRACT

An approach is provided to utilize experiences of a user community to identify software problems and communicate resolutions to such problems. Error reports are received from installed software systems in the user community. From these reports, a set of problematic usage patterns are generated, with each of the usage patterns having a confidence factor that is increased based on the number of problem reports that match the usage pattern. The problematic usage patterns are matched to sections of code corresponding to the installed software system with sections of code being identified with problematic usage patterns having confidence factors greater than a given threshold.

### BACKGROUND OF THE INVENTION

Software applications often experience incorrect, problematic, or sub-optimal usage patterns. Current approaches are ineffective to identify and resolve software errors based on usage patterns. One current approach is the use of code analysis tools that scan software source code or monitor running applications to detect problematic usage patterns. The templates these code analysis tools use to detect such usage patterns are manually created by people knowledgeable of the patterns. These code analysis tools analyze software by executing programs on a real or virtual processor. For code analysis to be effective, however, the program needs to be executed with sufficient test inputs to produce interesting behavior, including the discovery of errors. Use of software testing techniques such as code coverage helps ensure that an adequate portion of the program's set of possible behaviors has been observed by the code analysis tool. One challenge to using code analysis tools is that the effect that instrumentation has on the execution of the program.

Another current approach are the use of bug report postings. Users of software report usage patterns that they find to be problematic, posting these in a central location such as on a web site. Other users of the software manually read such reports and manually check their own use of that software for any of the reported usage patterns. A bug reporting system is a software application that is designed to help keep track of reported software bugs found in software. Many bug reporting systems allow users to enter bug reports directly. Other bug reporting systems are used only internally in a company or organization doing software development.

A third approach is automated error reporting. Automated error reporting is a technology that automatically collects program data back to the vendor when the program encounters unhandled exceptions on end-users' machines. A typical error report includes a full stack trace and details about the context of the exception (e.g. values of all the local variables). However, a software vendor can use automated error reporting to retrieve many different types of data, including log files and screenshots. Automated error reporting is most useful in two circumstances. First, during the pre-release phase (e.g. beta testing), when the vendor desires early user feedback in order to produce a stable software application. Second, during post-release maintenance, when the software vendor wants to reduce the time it takes to debug and repair the software by receiving enough information from users to understand the context of the exceptions that occur with the software. The error report contains information about the error as well as the execution environment. Traditionally, the application vendor manually analyzes the reports and uses that information to diagnose the problem and issue a fixed version of the application. The vendor manually creates a known solution and places it in a repository so that when subsequent error reports of the same problem arrive they can be matched to the known solution. In this approach, other users of the software application have no access to the error reports and may be unaware of the problem until the vendor issues the fixed version of the software.

### SUMMARY

An approach is provided to utilize experiences of a user community to identify software problems and communicate resolutions to such problems. Error reports are received from installed software systems in the user community. From these reports, a set of problematic usage patterns are generated, with each of the usage patterns having a confidence factor that is increased based on the number of problem reports that match the usage pattern. The problematic usage patterns are matched to sections of code corresponding to the installed software system with sections of code being identified with problematic usage patterns having confidence factors greater than a given threshold.

In one embodiment the problematic usage patterns indicate a processing environment. In this embodiment, a tester sets a test environment to the processing environment indicated by the selected problematic usage pattern and tests the identified section of code in the test environment. The selected problematic usage pattern is identified as a false positive in response to the testing failing to result in an error indicated by the selected problematic usage pattern. The confidence factor of the selected problematic usage pattern is decreased in response to identifying the pattern as a false positive. In a further embodiment, test environment elements that differ from the processing environment are identified with these identified test environment elements being retained as possible usage pattern resolutions pertaining to the selected problematic usage pattern. When a subsequent error report is received from a user of one of the installed software systems in the user community with a matching the problematic usage pattern, the possible usage pattern resolutions are retrieved and transmitting back to the user as a possible fix to the problem being experienced by the user.

After initialization and configuration of the software system, configuration reports are received from successfully installed systems with each of the configuration reports including a number of configuration elements. A set of success-based usage patterns are generated based on an analysis of the received configuration reports. When another user is installing the software system, a deployment request is received that includes one or more environment elements pertaining to the system where the software is being installed. The environment elements that pertain to the new install system are compared with the success-based usage patterns, with the comparison resulting in a set of the success-based usage patterns that match the new system install environment. Configuration parameter values are then recommended as input values to the installation of the software system on the new install system. In a further embodiment, pre-requisite software programs are recommended to the user of the new install system based on the set of success-based usage patterns.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various entities and components used in identifying usage patterns in a software offering;

FIG. 4 is a depiction of a flowchart showing the logic used in communicating between the user community and a usage pattern service to report errors and distribute software fixes;

FIG. 5 is a depiction of a flowchart showing the logic used in the usage pattern creator to create usage patterns based on received error data;

FIG. 6 is a depiction of a flowchart showing the logic used in communicating between the user community and the usage pattern service to provide users with usage pattern data during installation and configuration of the software;

FIG. 7 is a depiction of a flowchart showing the logic used by users to install and configure the software using usage pattern data;

FIG. 8 is a depiction of a flowchart showing the logic used by the usage pattern creator to create usage patterns based on configuration and evaluation data;

FIG. 9 is a depiction of a flowchart showing the logic used during code development and maintenance using usage pattern data;

FIG. 10 is a depiction of a flowchart showing the logic performed by a coding tool that allows developers to work with source code and provides the developers with usage pattern data to assist in coding modifications; and

FIG. 11 is a depiction of a flowchart showing the logic during code development and maintenance to test for possible false positives in the generated usage pattern data.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

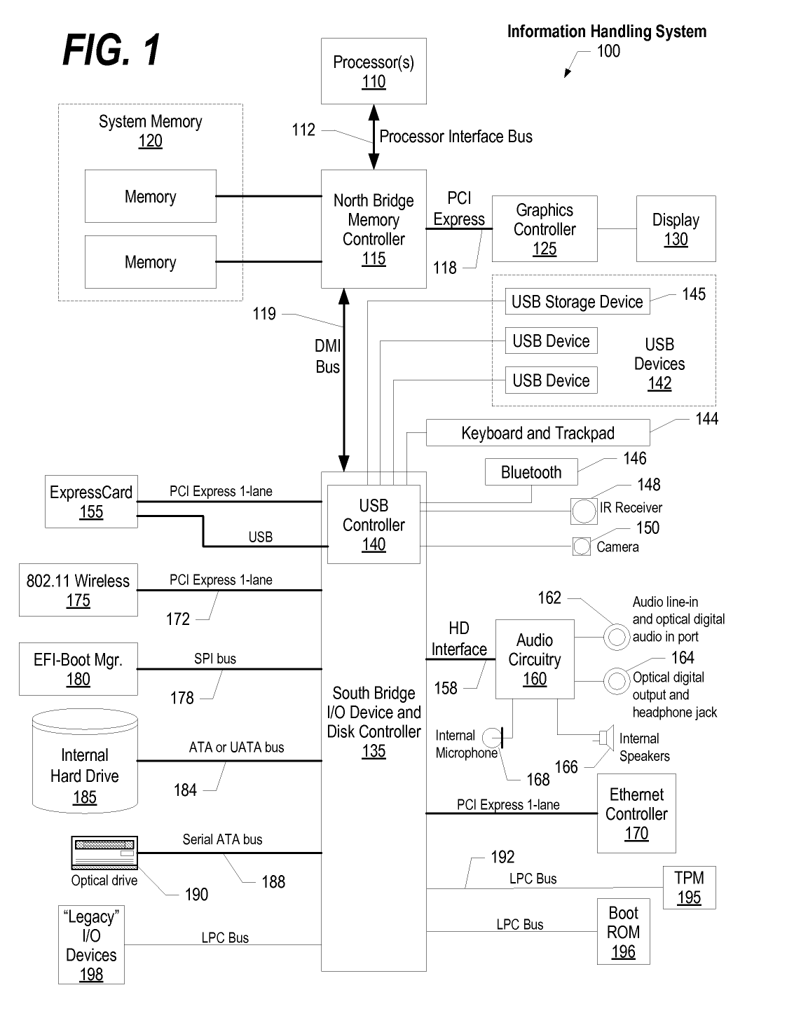

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

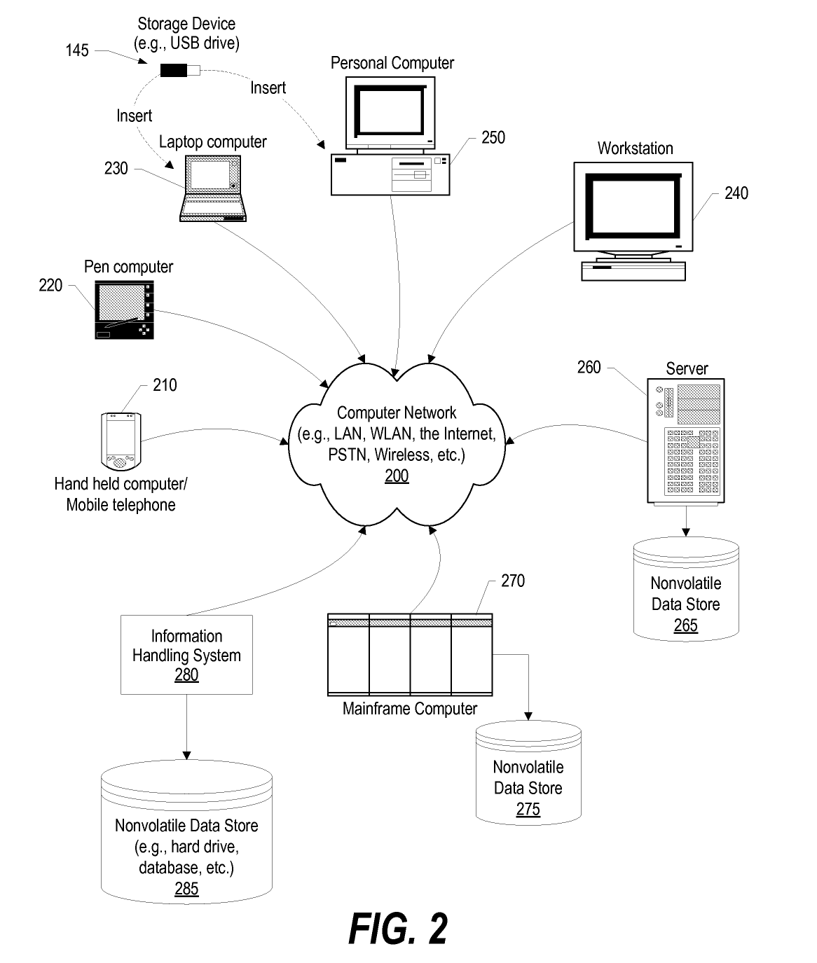

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

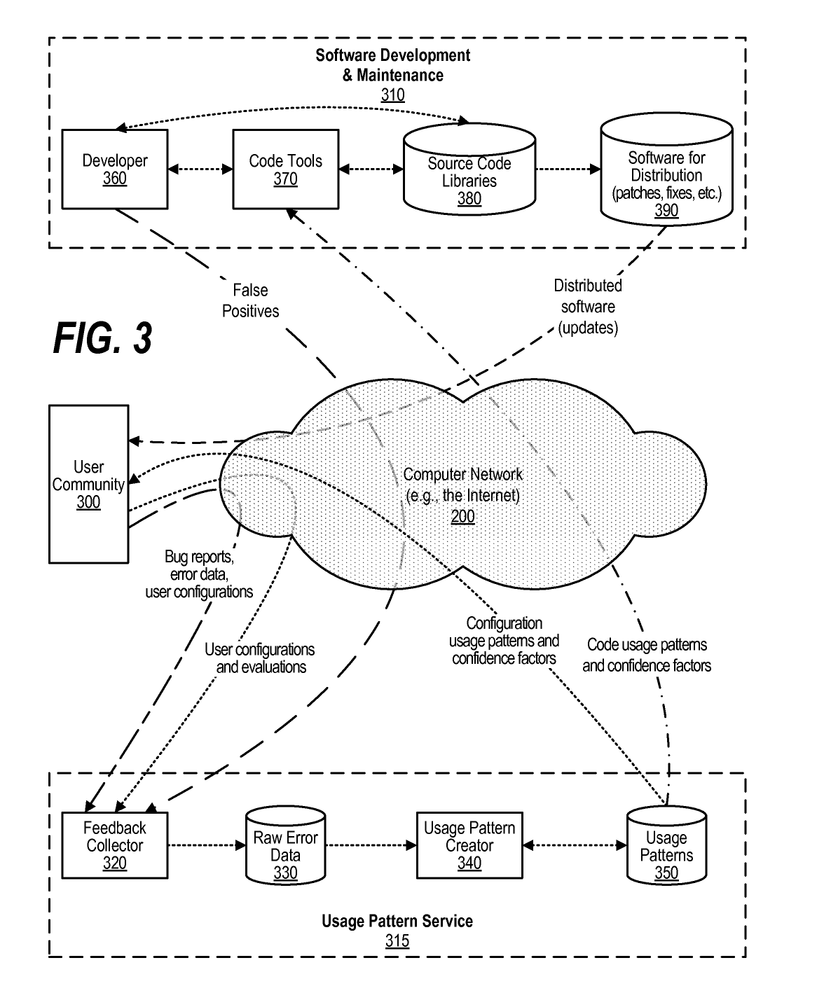

FIGS. 3-11 depict an approach that can be executed on an information handling system and computer network as shown in FIGS. 1-2. A system and method of using “crowd” experiences from a user community to generate usage pattern data to identify software problems and resolve such problems is disclosed. The approach shown is, in one embodiment, fully automated. By leveraging the experience of the “crowd” of application users, the system discovers usage patterns that are problematic. Further, the approach leverages bug reports posted by applications users as well as using an automated collection of data related to a problematic experiences. Furthermore, in one embodiment, a code analysis tool or runtime monitoring tool is utilized to automatically check source code or a running application for instances of a usage pattern that is known to be problematic. In this manner, the approach allows for the automated analysis of data, such as stack traces, inventory of execution environment, and installation parameters, from collections of gathered error reports.

The usage pattern creator is a tool that identifies common elements in error reports. The usage pattern creator may find that calls to a particular API cause problems only when another API is implemented in a particular library. In one embodiment, a feedback loop is included in the tool. For example, a user, such as a developer, might run a code analyzer that detects a usage pattern which was problematic for someone else, such as an end user, but causes no problems for this user. Such instances can be reported as a “false positives.” False positives are fed back to the usage pattern creator from code analysis tools or runtime monitoring tools to further refine the usage pattern or reduce a confidence factor associated with the usage pattern. The code analyzer provides an indication of the likelihood that the reported usage pattern causes a problem, based on this feedback from the user community. The usage pattern creator automatically identifies differences between true error conditions and false positives to suggest resolution tactics.

Compilers and source code editing tools are augmented to flag problematic usage patterns that have been automatically collected from the user community. The tool could be used to analyze code that makes calls to any execution environments: browsers, operating systems, application servers, databases, etc. For instance, software pre-requisite scanners, installation utilities, and configuration tools can be augmented to flag combinations of configuration parameters and run time environment elements that are known to be problematic. Known working combinations of configuration parameters and runtime elements could also be fed automatically to the usage pattern creator. Monitoring tools could then check for differences from known working combinations. When a user installs the software, the system keeps a record of input choices and configuration options. Upon successful installation of the software, the inputs for all configuration pages are retrieved so that other users can see how current user's responded to configuration prompts to successfully install the software in a given environment.

The approach discussed above is further described in FIGS. 3-11 and accompanying detailed descriptions, discussed below. These figures and related descriptions provide further details related to one or more embodiments that utilize experiences of a user community to identify software problems and communicate resolutions to such problems.

FIG. 3 is a component diagram showing the various entities and components used in identifying usage patterns in a software offering. User community 300 is a community of users that have installed and are using software systems from a particular vendor. When the users in the community initially, and successfully, installed the software system, their systems transmitted user configuration data to usage pattern service 315, such as a process running at a vendor computer system to assist in maintenance and development of the software system. Then, while using the software systems, error reports, such as bug reports and other error data, are also transmitted from the user's systems 300 to usage pattern service 315. Transmissions between the user community and the vendor's system are facilitated by use of computer network 200, such as the Internet.

Usage pattern service 315 includes a number of processes and data stores. Feedback collector 320 receives the error reports and configuration data from user community 300 as described above. In addition, feedback collector 320 also collects false positive data from code developer 360 when the code developer tests a problematic usage pattern that does not generate errors experienced by the user community. Raw error data 330 is a data store where the data collected by feedback collector 320 is stored. Usage pattern creator 340, described in subsequent figures in more detail, is a process that processes raw error data 330 and generates usage patterns 350. As is more fully described infra, usage patterns 350 includes both problematic usage patterns (e.g., those related to error reports, etc.) as well as success-based usage patterns which are related to successful installation of the software.

Software maintenance and development operations 310 include a number of entities, processes, and data stores. Developer 360 is typically a trained software professional tasked with maintaining and developing the software that is being distributed to user community 300. Developer 360 utilizes code tools 370 which are various tools such as source code editors and compilers. Code tools 370 utilize usage patterns created by the usage pattern creator and stored in usage patterns data store 350. The code tools are able to identify, in source code libraries 380, usage patterns that have been reported by user community 300. Source code libraries 380 include source code used by one or more software product offerings. Generalized software programs, procedures, or functions, may be coded and stored in source code libraries 380. Such generalized software programs may be used by a variety of software product offerings.

Errors that have been reported by numerous end users will have usage patterns with higher confidence factors allowing code tools 370, as well as developer 360, to identify possible errors in source code libraries 380 that are more problematic. Using the data from usage patterns 350, the developer can establish a test environment similar to end users that experienced problems with the software. If the developer does not experience the problems reported by the end users, then the usage pattern is identified as a false positive and transmitted to feedback collector 320 for processing. In addition, the system notes differences between the developer's test system and the end users' systems and generates a possible usage pattern resolution that is shared with the user community. End users in user community 330 can apply changes noted in the usage pattern resolution to possibly fix the error on their systems. When the same error occurs on the test system as was reported in the usage patterns, the developer can modify source code libraries 380, resulting in distribution software 390, such as patches, fixes, new release, etc. that address the errors corresponding to the usage patterns. The software program, routine, or function (software) updated in source code libraries 380 may be used by various software product offerings. In this manner, errors reported by users of a first software product offering may result in a fix being made to a software routine that is utilized by not only the first software product offering but also by other software product offerings. Consequently, errors reported in the first software product offering may result in improvements made to other software product offerings due to the use of common software routines in source code libraries 380.

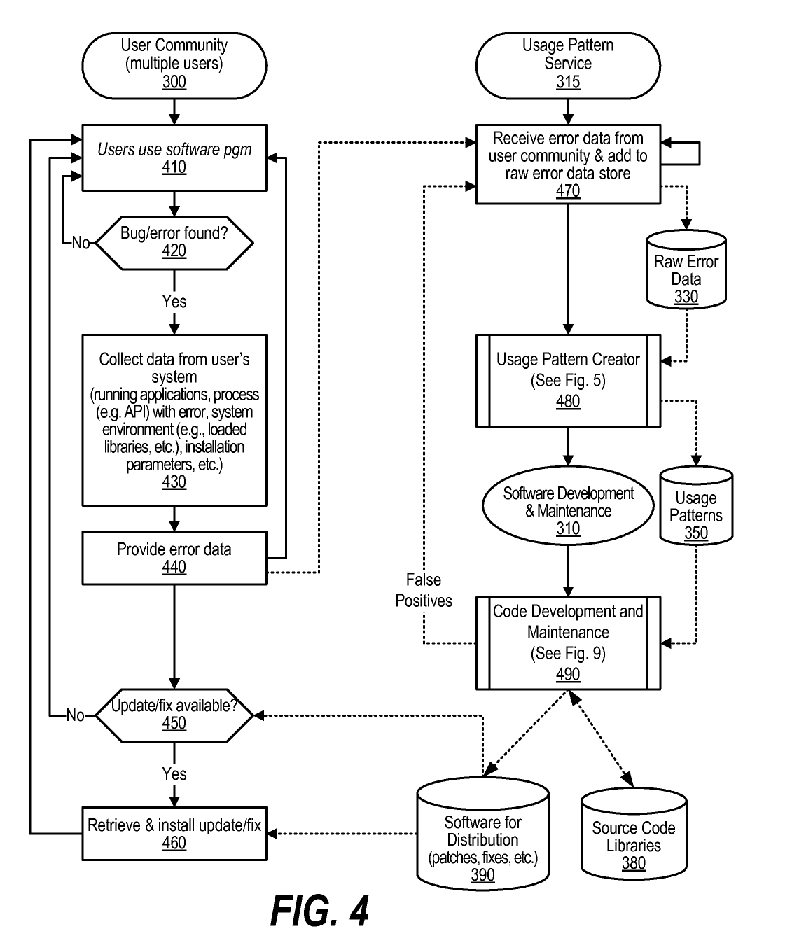

FIG. 4 is a depiction of a flowchart showing the logic used in communicating between the user community and a usage pattern service to report errors and distribute software fixes. User community 300 installs the software product and, at step 410, executes and uses the software. A decision is made as to whether a bug or other type of software error is found or detected when running the software (decision 420). If no errors are detected, decision 420 loops back and the end users continue using the software program. This looping continues until an error is detected in the software, at which point decision 420 branches to the “yes” branch to process the error.

At step 430, data is collected from user's system with the data collected including such elements such as other running applications, the process (e.g. API) in which the error was detected, the user's system environment (e.g., loaded libraries, etc.), installation parameters used when the software was installed, etc. At step 440, the error related data that was collected in step 430 is transmitted (e.g., via a computer network such as the Internet, etc.) to the vendor's usage pattern service 315. Additionally, the user's system checks as to whether a software update or other type of fix is available from the vendor that might address the problem being experienced (decision 450). If no software update or other type of fix is available, then decision 450 branches to the “no” branch which loops back and allows the user to continue using the software at step 410. On the other hand, if a software update or other type of fix is available, then decision 450 branches to the “yes” branch whereupon, at step 460, the user's system retrieves and installs the software update/fix from the vendor's distribution software data store 390 (e.g., downloading the update/fix from the vendor over a computer network such as the Internet).

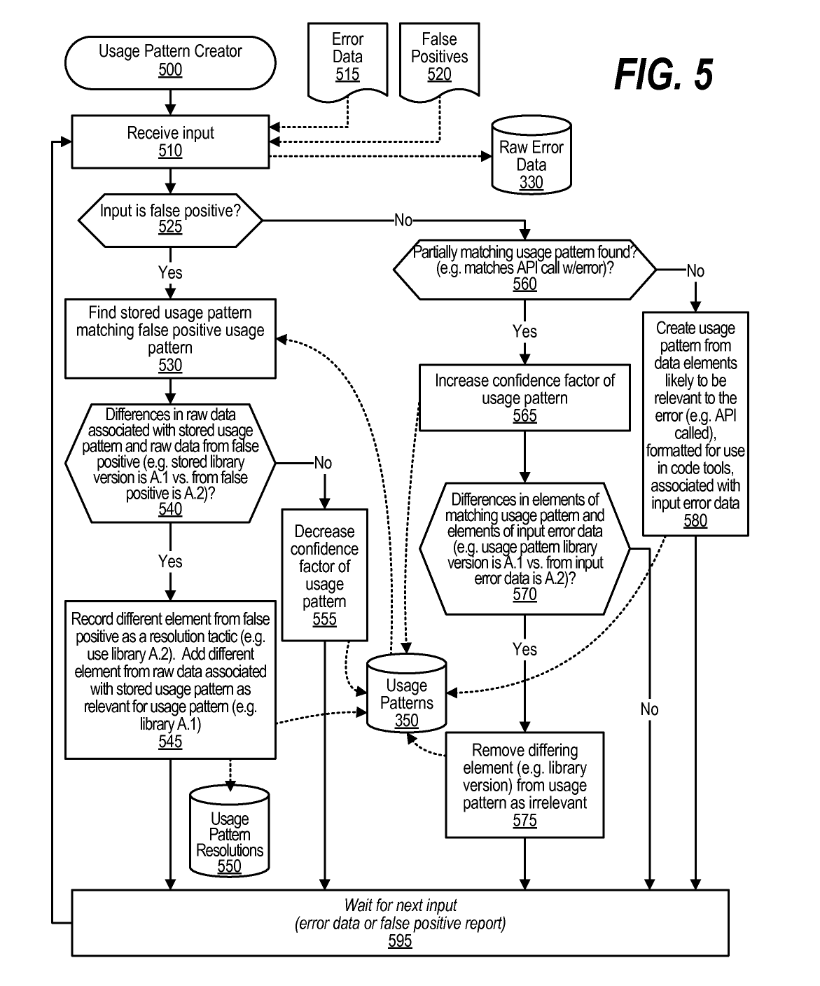

Usage pattern service processing commences at 310 whereupon, at step 470, the usage pattern service receives the error data transmitted from a computer system in the user community and adds the received error data to raw error data store 330. At predefined process 480, the vendor runs the usage pattern creator process to generate usage patterns from the received error data (see FIG. 5 and corresponding text for processing details). The generated usage patterns are stored with other previously generated usage patterns in data store 350. Software development and maintenance 310 addresses possible errors in the software as shown at the top of FIG. 3. At predefined process 490, developers perform a code development and maintenance process using the usage patterns stored in data store 350 to identify sections of code that may be responsible for causing errors. False positives, which are usage patterns that have been tested but found not to cause errors, are reported back to step 470 and used to reduce the confidence factors associated with the corresponding usage pattern. Usage patterns found to cause problems in the software are addressed through updates to the software source code libraries 380. In addition, predefined process 490 generated distribution software 390, such as updates and fixes, that are available for distribution to the user community.

FIG. 5 is a depiction of a flowchart showing the logic used in the usage pattern creator to create problematic usage patterns based on received error data. Processing commences at 500 whereupon, at step 510, input is received and stored in raw error data 330. As shown, input is received from two general sources. Error data 515 is an input that is received from users running the software in the user community when they encounter an error with the software. False positives 520 is an input that is received from a developer when testing the software in a test environment set according to a usage pattern and the developer does not encounter the error reported by the user community.

A decision is made as to whether the input received is a false positive input (decision 525). If the input is a false positive input, then decision 525 branches to the “yes” branch to process the false positive input. At step 530, the process identifies the stored usage pattern in data store 350 that matches the usage pattern where the false positive was identified. A decision is made as to whether there are differences in the raw data associated with the stored usage pattern and the raw data from the false positive input (decision 540). For example, the usage pattern may have been using library version “A.1” where the test environment that detected the false positive is using library version “A.2”. This discovery may mean that the error associated with the usage pattern does not occur when the different library is used. If such a difference in environments is discovered, then decision 540 branches to the “yes” branch whereupon, at step 545, the process records the different element from false positive input as a possible resolution tactic (e.g. use library “A.2” instead of library “A.1”, etc.). In addition, at step 545, the process adds the different element from raw data associated with the stored usage pattern as relevant for usage pattern (e.g. library “A.1”). The possible usage pattern resolutions are stored in data store 550. On the other hand, if no such differences are noted between the false positive input and the usage pattern, then decision 540 branches to the “no” branch whereupon, at step 555, the process decreases the confidence factor of the usage pattern.

Returning to decision 525, if the input is not a false positive input but, instead, is an error report from the user community, then decision 525 branches to the “no” branch to process the error report. A decision is made as to whether an existing usage pattern from data store 350 matches, or partially matches, the error being reported in the error report (decision 560). If an existing usage pattern from data store 350 matches, or partially matches, the error being reported in the error report, then decision 560 branches to the “yes” branch whereupon, at step 565 the confidence factor associated with the usage pattern is increased to indicate that the error corresponding to the usage pattern has been reported my more users from the user community. A decision is made as to whether there are differences between the elements included in the error report and the elements included in the matching usage pattern (decision 570). For example, the usage pattern may indicate a library version is “A.1”, while the input error report indicates that the system reporting the error is using library version “A.2”. If there are differences in the elements of the error report and the usage pattern, then decision 570 branches to the “yes” branch whereupon, at step 575, the different element(s) are removed from the usage pattern (e.g., the library version from the above example), because such elements are now identified as being irrelevant with regards to the usage pattern. On the other hand, if there are no differences in elements of the error report and the usage pattern, then decision 570 branches to the “no” branch bypassing step 575.

Returning to decision 560, if there are no existing usage patterns from data store 350 that match, or partially match, the error being reported in the error report, then decision 560 branches to the “no” branch whereupon, at step 580 a new usage pattern is created. At step 580, the process creates the new usage pattern from the data elements likely to be relevant to the error (e.g. API called, library being used, etc.), with the usage pattern being formatted for use in code tools and associated with the received input error data. As shown, the new usage pattern is stored in data store 350.

After the input received at step 510 has been processed as described above, at step 595 processing waits for the next input to be received at the usage pattern creator. When the next input is received, either an error report or a false positive report, processing loops back to step 510 to receive and process the newly received input as described above.

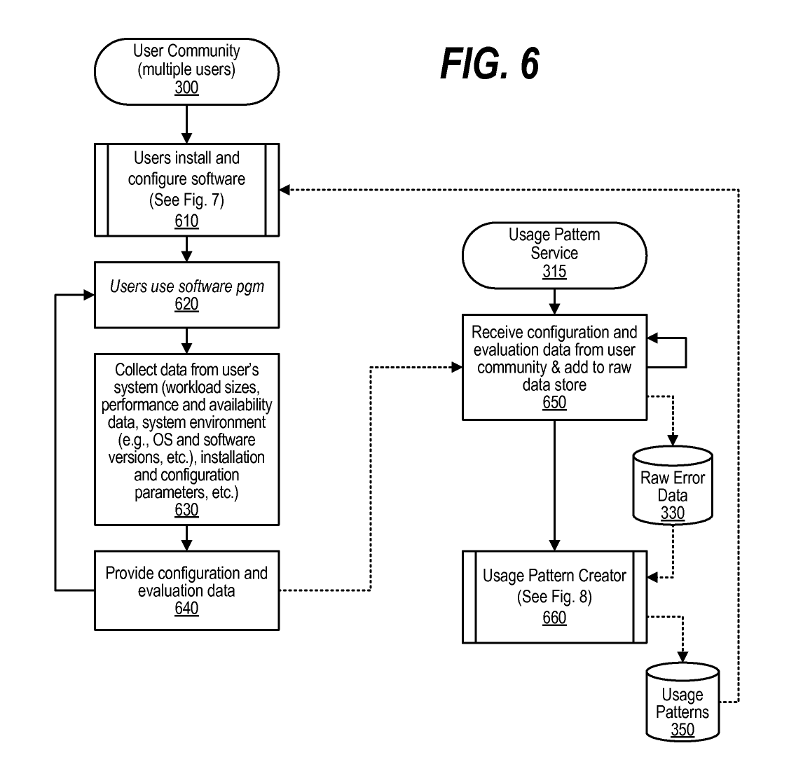

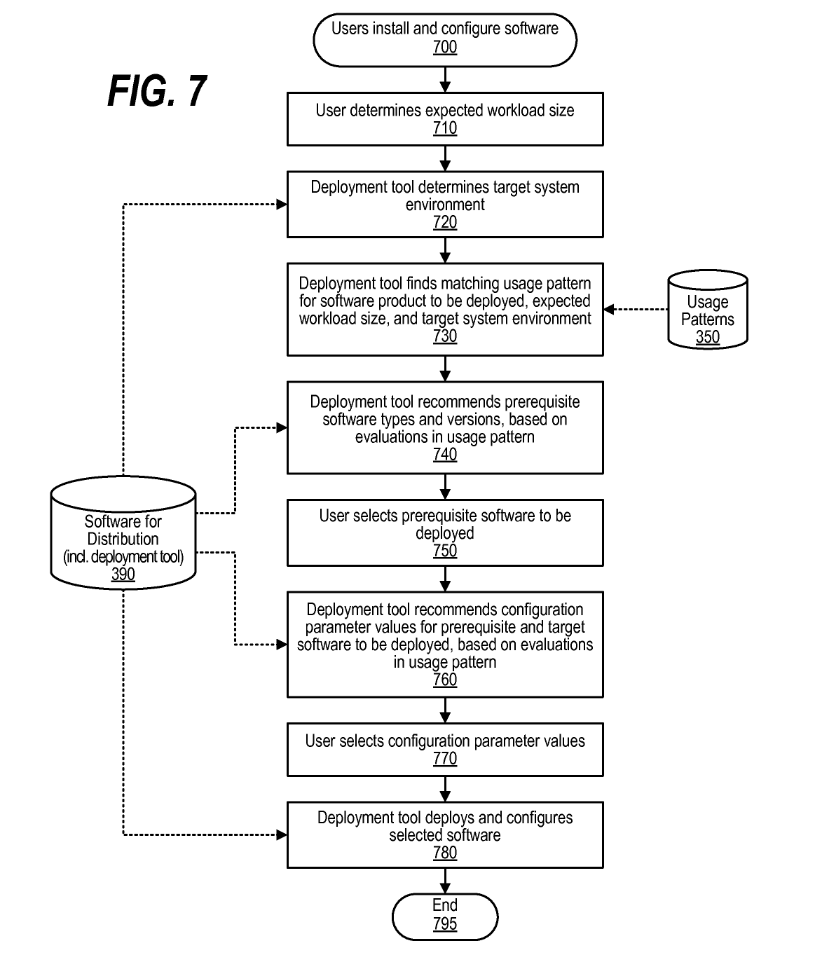

FIG. 6 is a depiction of a flowchart showing the logic used in communicating between the user community and the usage pattern service to provide users with usage pattern data during installation and configuration of the software. User community processing is shown commencing at 300 whereupon, at predefined process 610, the users install and configure the software on their systems (see FIG. 7 and corresponding text for processing details). After the system has been installed, at step 620 the users start using the software that has been installed. At step 630, a process collects data from user's system. The information collected can include workload sizes, performance and availability data, system environment (e.g., OS and software versions, etc.), installation and configuration parameters, etc. At step 640, the user's system transmits the configuration and evaluation data to the vendor's usage pattern service via a computer network, such as the Internet.

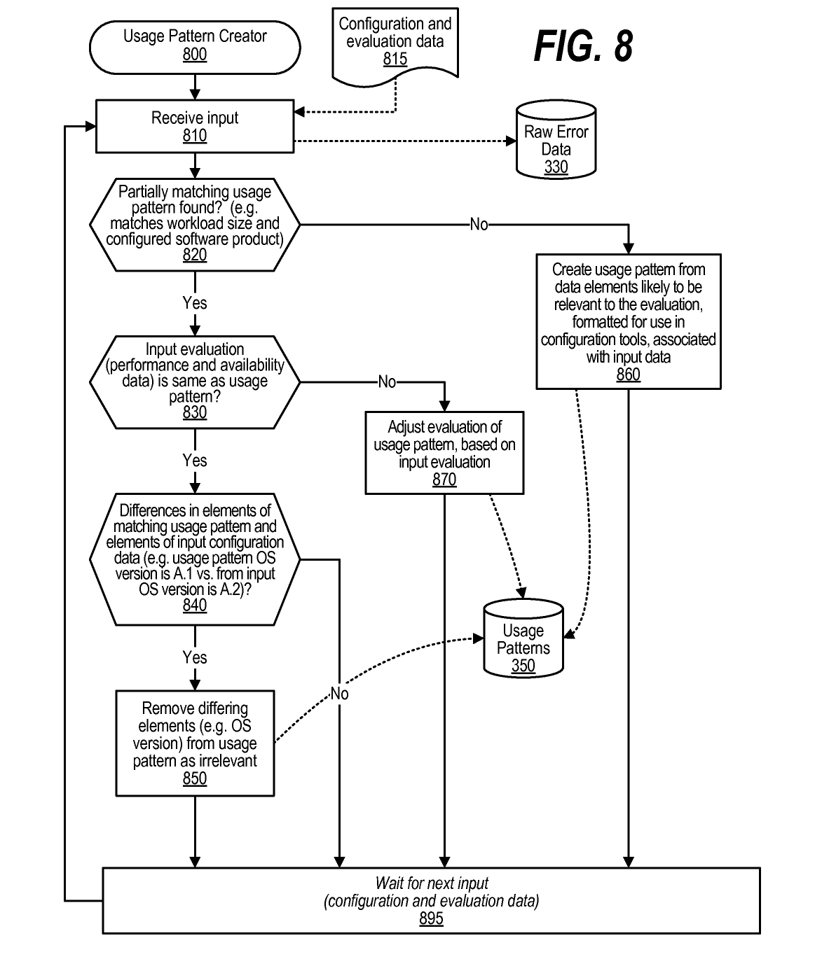

Usage pattern service processing is shown commencing at 315 whereupon, at step 650, the usage pattern service receives the configuration and evaluation data from the user community and adds the received data to raw data store 330. At predefined process 660, the usage pattern creator process is performed on the raw data to generate usage patterns that are stored in data store 350 (see FIG. 8 and corresponding text for processing details).

FIG. 7 is a depiction of a flowchart showing the logic used by users to install and configure the software using usage pattern data. Processing commences at 700 whereupon, at step 710, the user installing the software determines the expected workload size. At step 720, the deployment tool is retrieved from data store 390 and executed to determine the target (install) system environment. At step 730, the deployment tool identifies matching success-based usage patterns, from data store 350, for the software being deployed along with the expected workload size and the target system environment. The success-based usage patterns were previously generated based on successful installations and configurations of the software by other users on other systems. At step 740, the deployment tool recommends any prerequisite software types and versions based on the evaluation of the matching success-based usage patterns At step 750, the user selects prerequisite software and versions to be deployed based on the recommendations provided by the deployment tool. At step 760, after the prerequisite software has been installed, the deployment tool recommends configuration parameter values for the prerequisite software and the target (vendor's) software that is being deployed, based on evaluations in the matching success-based usage patterns. At step 770, the user selects configuration parameter values based on the recommendations provided by the deployment tool. Finally, at step 780, the deployment tool deploys and configures the selected (vendor) software using the parameter values selected by the user which were based on the recommendations provided by the deployment tool. Processing thereafter ends at 795.

FIG. 8 is a depiction of a flowchart showing the logic used by the usage pattern creator to create success-based usage patterns based on configuration and evaluation data. Usage pattern creator processing commences at 800 whereupon, at step 810 the process receives input with the input being configuration and evaluation data 815 that is received from the user community based on successful installations of the software. The received input is stored in raw data store 330.

A decision is made as to whether a matching, or partially matching, success-based usage pattern is identified in usage pattern data store 350 (decision 820). For example, a usage pattern that matches the workload size and the configured software product from the received input. If a matching, or partially matching, success-based usage pattern is identified, then decision 820 branches to the “yes” branch for further processing. A decision is made as to whether the received input evaluation regarding performance and availability data is the same, or similar to, the identified success-based usage pattern (decision 830). If the received input evaluation regarding performance and availability data is the same, or similar to, the identified success-based usage pattern, then decision 830 branches to the “yes” branch whereupon a decision is made as to whether the process detects any differences in the elements of the matching usage pattern and the elements of the input configuration data (decision 840). For example, the success-based usage pattern operating system version is “A.1” while the received input configuration data is from a system with an operating system version of “A.2”. If such differences are identified, then decision 840 branches to the “yes” branch whereupon, at step 850, the process remove such differing elements (e.g. the operating system version, etc.) from the success-based usage pattern as being irrelevant. On the other hand, if no such differences are noted, then decision 840 branches to the “no” branch bypassing step 850.

Returning to decision 830, if the received input evaluation regarding performance and availability data is not the same, or similar to, the identified success-based usage pattern, then decision 830 branches to the “no” branch whereupon, at step 870, the success-based usage pattern is adjusted based on the input evaluation that was received at step 810.

Finally, returning to decision 820, if a matching, or partially matching, success-based usage pattern is not identified, then decision 820 branches to the “no” branch for further processing. At step 860, the process creates a new success-based usage pattern from the data elements likely to be relevant to the evaluation, with the created success-based usage pattern being formatted for use by the configuration tools and associated with the input data received at step 810.

After the input received at step 810 has been processed as described above, at step 895 processing waits for the next input to be received at the success-based usage pattern creator. When the next input is received (configuration and evaluation data from another system after a successful installation), processing loops back to step 810 to receive and process the newly received input as described above.

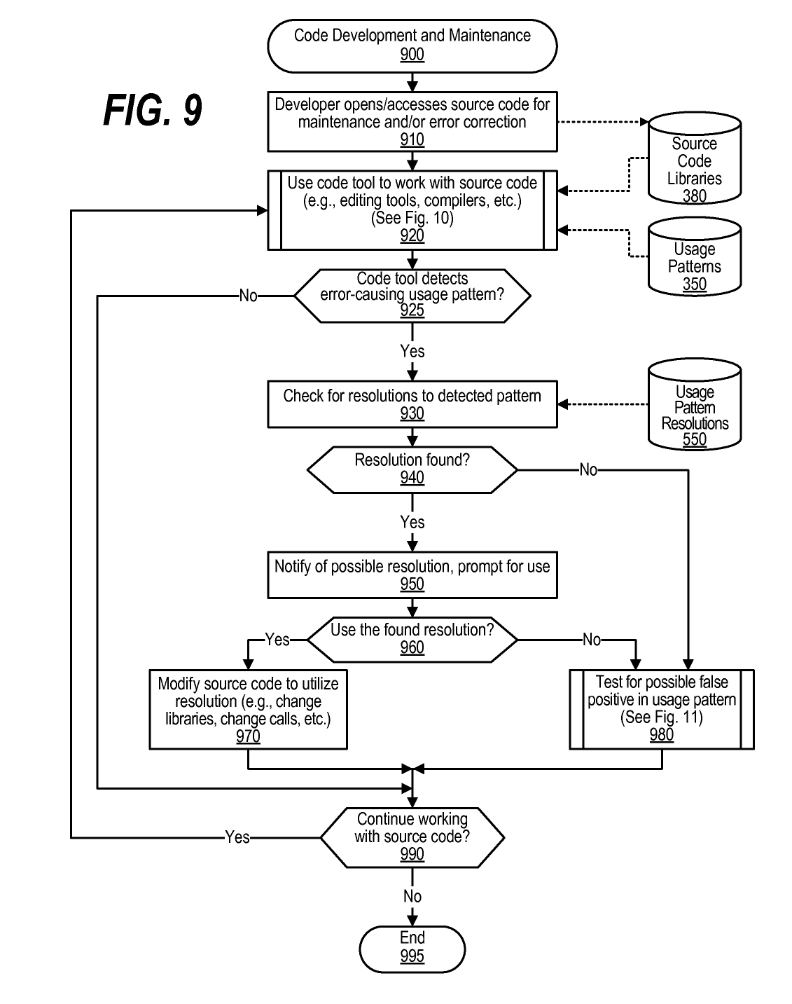

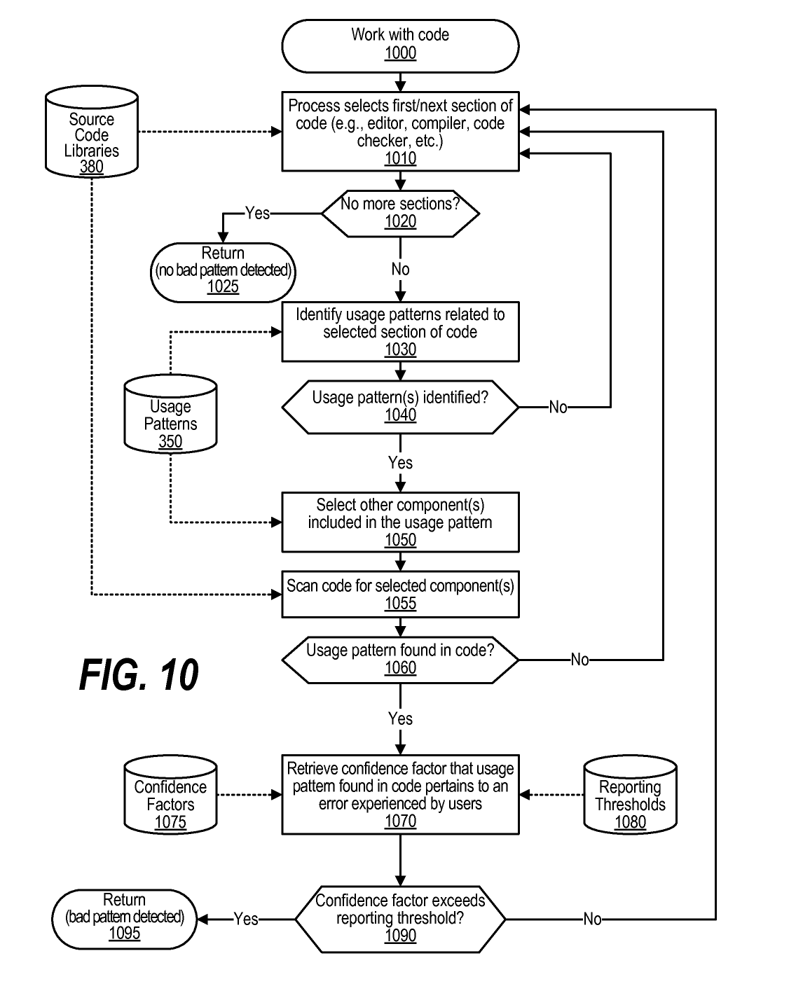

FIG. 9 is a depiction of a flowchart showing the logic used during code development and maintenance using problematic usage pattern data. Code development and maintenance processing commences at 900 whereupon, at step 910, a developer working on software development and/or maintenance opens or otherwise accesses source code from source code libraries 380 for either software maintenance or error correction. At predefined process 920, the developer users a code tool to work with the source code with the code tool utilizing problematic usage pattern data from data store 350 (see FIG. 10 and corresponding text for processing details). The code tool may be a source editing tool, a compiler, a debugger, a code analyzer, or any other tool used to work with source code that may benefit from the problematic usage pattern data.

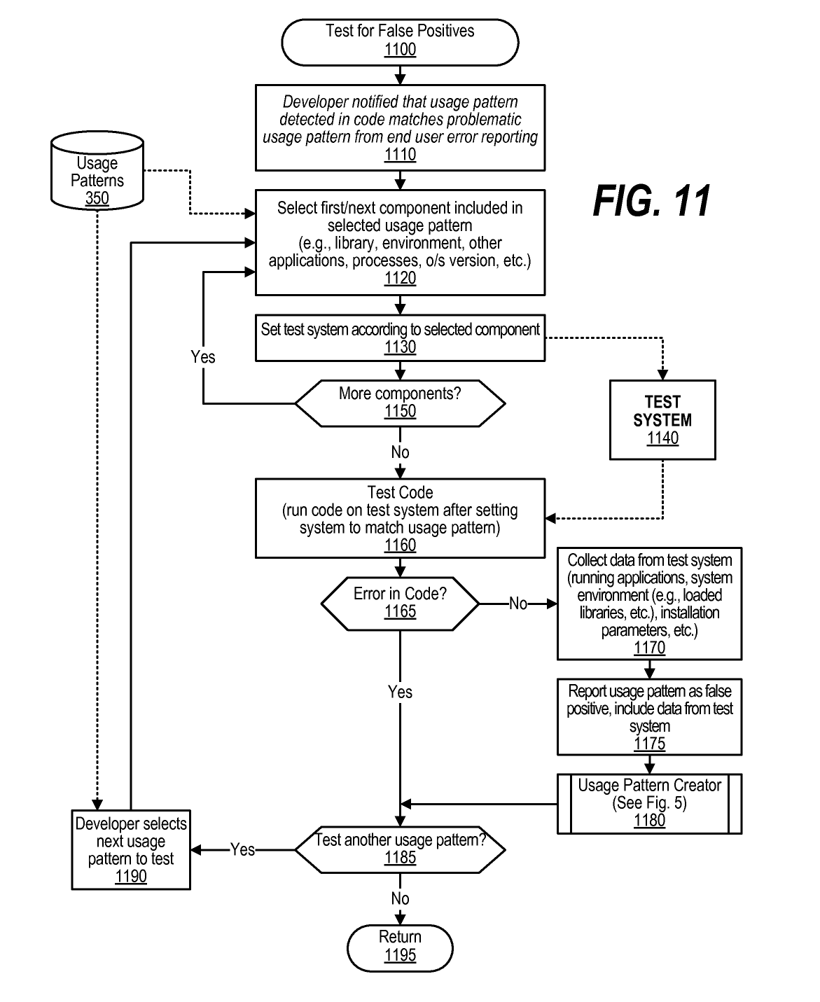

A decision is made as to whether the code tool detects a problematic usage pattern while working with the code (decision 925). If a problematic usage pattern is detected, then decision 925 branches to the “yes” branch whereupon, at step 930, the process checks for possible resolutions to the problem that have previously been discovered and stored in data store 550 (see FIG. 5 and corresponding text for processing details regarding discovery of problematic usage pattern resolutions). A decision is made as to whether a possible resolution to the detected problematic usage pattern has been found (decision 940). If a possible resolution has been found, then decision 940 branches to the “yes” branch whereupon, at step 950, the process informs the developer of the possible resolution and prompts the developer as to whether to use the possible resolution that was found. A decision is made as to whether the developer has decided to use the possible resolution (decision 960). If the developer wishes to use the possible resolution, then decision 960 branches to the “yes” branch whereupon, at step 970, the process modifies the source code to utilize the possible resolution (e.g., use a different library, change an API call, etc.). If either the developer decides against using the found resolution (with decision 960 branching to the “no” branch) or if a possible resolution was not found (with decision 940 branching to the “no” branch), then, at step predefined process 980, the process and the developer tests for a possible false positive in the problematic usage pattern (see FIG. 11 and corresponding text for processing details).

A decision is made as to whether the developer wishes to continue working with source code using the code tool (decision 990). If the developer wants to keep working with the source code with the code tool, then decision 990 branches to the “yes” branch which loops back to predefined process 920 where the developer works with the source code using the code tool This looping continues until the developer no longer wishes to work with the source code with the code tool, at which point decision 990 branches to the “no” branch and processing ends at 995.

FIG. 10 is a depiction of a flowchart showing the logic performed by a coding tool that allows developers to work with source code and provides the developers with usage pattern data to assist in coding modifications. Processing commences at 1000 whereupon, at step 1010, the code tool process selects the first section of code retrieved or selected by the developer (e.g., a source editing tool, a compiler, a debugger, a code analyzer, or any other tool used to work with source code). A decision is made as to whether the processing has reached the end of the source code that is being processed (decision 1020). When the end of the code is reached without detecting any problematic patterns, then decision 1020 will branch to the “yes” branch and return an indicator that no problematic patterns were detected at 1025. However, as this is the first section of code that is being processed, decision 1020 branches to the “no” branch whereupon, at step 1030, the process compares the selected section of code (e.g., a module, routine, etc.) with the problematic usage patterns stored in data store 350. A decision is made as to whether any problematic usage patters were identified matching the selected section of code (decision 1040). If no problematic usage patterns were detected, then decision 1040 branches to the “no” branch which loops back to select the next section of code to process. On the other hand, if one or more problematic usage patterns were detected, then decision 1040 branches to the “yes” branch for further processing.

At step 1050, the process select other component(s), or elements, included in the identified usage pattern. At step 1055, the process scans the source code for the selected component(s), or elements. A decision is made as to whether the problematic usage pattern is found in the source code (decision 1060). If the problematic usage pattern is not found in the source code, then decision 1060 branches to the “no” branch which loops back to select the next section of code to process. On the other hand, if the problematic usage pattern is found in the source code, then decision 1060 branches to the “yes” branch for further processing. At step 1070, the process retrieve a confidence factor pertaining to the problematic usage pattern found in the source code. A high confidence factor indicates that error reports matching the problematic usage pattern were received by multiple users from the user community, while a low confidence factor may indicate that few users submitted error reports matching the problematic usage pattern or that false positives have previously been detected for the identified problematic usage pattern. The confidence factors are retrieved from data store 1075. In addition, a confidence factor reporting threshold is retrieved from data store 1080. A decision is made as to whether the confidence factor pertaining to the identified problematic usage pattern is greater than the reporting threshold (decision 1090). If the confidence factor exceeds the reporting threshold, then decision 1090 branches to the “yes” branch whereupon processing returns to the calling routine (see FIG. 9) with a return code indicating that a problematic usage pattern was detected for the selected area of code. On the other hand, if the confidence factor is not greater than the reporting threshold, then decision 1090 branches to the “no” branch which loops back to select the next section of code to process.

FIG. 11 is a depiction of a flowchart showing the logic during code development and maintenance to test for possible false positives in the generated usage pattern data. The test for false positives in a problematic usage pattern commences at 1100 whereupon, at step 1110, the developer was notified that usage pattern detected in code matches problematic usage pattern from end user error reporting (see bottom of FIG. 10). At step 1120, the false positive testing process select the first component included in the selected problematic usage pattern (e.g., library, environment, other applications, processes, o/s version, etc.). At step 1130, test system 1140 is set up according to the selected component. A decision is made as to whether there are more components to process to create the test system (decision 1150). If there are more components, then decision 1150 branches to the “yes” branch which loops back to select the next component and further setup the test system. This looping continues until there are no more components to process as indicated by the problematic usage pattern, at which point decision 1150 branches to the “no” branch for further processing.

At step 1160, the developer test the code on test system 1140 after having setup the test system to match the components indicated by the problematic usage pattern. A decision is made as to whether an error is detected in the code while running on the test system (decision 1165). If no error is detected in the code running on the test system, decision 1165 branches to the “no” branch to process the detected false positive. At step 1170, the process collects data from the test system, such as running applications, the system environment (e.g., loaded libraries, etc.), the installation parameters, etc.). At step 1175, the process report the selected problematic usage pattern as a false positive. Data collected from the test system is included in the false positive report. At predefined process 1180, the usage pattern creator is performed using the reported false positive data (see FIG. 5 and corresponding text for processing details). Returning to decision 1165, if an error is detected in the code running on the test system, then decision 1165 branches to the “no” branch bypassing steps 1170, 1175, and predefined process 1180.

After the problematic usage pattern has been tested, a decision is made as to whether the developer wishes to test another problematic usage pattern with the test system (decision 1185). If the developer wishes to test another problematic usage pattern using the test system, then decision 1185 branches to the “yes” branch whereupon, at step 1190, the developer selects the next problematic usage pattern to test using test system 1140 and processing loops back to 1120 to adjust the test system according the newly selected problematic usage pattern and test the code on the test system. This looping continues until the developer does not wish to test another usage pattern on the test system, at which point decision 1185 branches to the “no” branch and processing returns to the calling routine (see FIG. 9) at 1195.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of software problem determination and resolution, the method comprising:
receiving, over a computer network, a plurality of error reports from a plurality of systems in a user community running a set of one or more software offerings that includes one or more sections of code;
generating a set of problematic usage patterns based on an analysis of the received error reports, wherein each of the usage patterns has a confidence factor;
increasing the confidence factors corresponding to a set of the problematic usage patterns in response to multiple received error reports matching the set of problematic usage patterns;
matching the problematic usage patterns to the one or more sections of code; and
identifying one of the sections of code based on the identified section of code matching a selected one of the problematic usage patterns and based on the selected problematic usage pattern having a confidence factor greater than a threshold.

2. The method of claim 1 wherein the sections of code are included in a plurality of different software offerings, and wherein the plurality of different software offerings includes the set of software offerings.

3. The method of claim 2 wherein the problematic usage patterns indicate a processing environment, the method further comprising:
setting a test environment to the processing environment indicated by the selected problematic usage pattern;
testing the identified section of code in the test environment;
identifying the selected problematic usage pattern as a false positive in response to the testing failing to result in an error indicated by the selected problematic usage pattern; and
decreasing the confidence factor of the selected problematic usage pattern in response to the identification of the false positive.

4. The method of claim 3 further comprising:
identifying one or more test environment elements that differ from the processing environment indicated by the selected problematic usage pattern;
retaining, in a data store, the identified test environment elements as possible usage pattern resolutions pertaining to the selected problematic usage pattern;
receiving, over the computer network, a subsequent error report from a user of one of the installed software systems in the user community;
generating a subsequent problematic usage pattern pertaining to the subsequent error report;
matching the subsequent problematic usage pattern to the selected problematic usage report;
retrieving the possible usage pattern resolutions from the data store; and
transmitting, over the computer network, the possible usage pattern resolutions to the user.

5. The method of claim 1 further comprising:
receiving, over the computer network, a plurality of configuration reports from a plurality of successfully installed software systems in the user community, wherein each of the configuration reports include a plurality of configuration elements; and
generating a set of success-based usage patterns based on an analysis of the received configuration reports.

6. The method of claim 5 further comprising:
receiving, over the computer network, a deployment request from a selected system in the user community that is commencing installation of the software system, wherein the deployment request includes one or more environment elements pertaining to the selected system;
comparing the environment elements that pertain to the selected system with the success-based usage patterns, the comparison resulting in a set of one or more of the success-based usage patterns that match the environment elements that pertain to the selected system; and
recommending one or more configuration parameter values as inputs to the installation of the software system on the selected system.

7. The method of claim 6 further comprising:
recommending, based on the set of success-based usage patterns, one or more pre-requisite software programs, wherein the recommendation further includes a version corresponding to each of the pre-requisite software programs; and
displaying the recommended pre-requisite software programs and versions to a user of the selected system prior to installation of the software system.

8. An information handling system comprising:
one or more processors;
a memory coupled to at least one of the processors;
a network adapter that connects the information handling system to a computer network; and
a set of instructions stored in the memory and executed by at least one of the processors, wherein the set of instructions perform actions of:
receiving, over the computer network, a plurality of error reports from a plurality of systems in a user community running a set of one or more software offerings that includes one or more sections of code;
generating a set of problematic usage patterns based on an analysis of the received error reports, wherein each of the usage patterns has a confidence factor;
increasing the confidence factors corresponding to a set of the problematic usage patterns in response to multiple received error reports matching the set of problematic usage patterns;
matching the problematic usage patterns to the one or more sections of code; and
identifying one of the sections of code based on the identified section of code matching a selected one of the problematic usage patterns and based on the selected problematic usage pattern having a confidence factor greater than a threshold.

9. The information handling system of claim 8 wherein the sections of code are included in a plurality of different software offerings, and wherein the plurality of different software offerings includes the set of software offerings.

10. The information handling system of claim 9 wherein the problematic usage patterns indicate a processing environment, and wherein the actions further comprise:
setting a test environment to the processing environment indicated by the selected problematic usage pattern;
testing the identified section of code in the test environment;
identifying the selected problematic usage pattern as a false positive in response to the testing failing to result in an error indicated by the selected problematic usage pattern; and
decreasing the confidence factor of the selected problematic usage pattern in response to the identification of the false positive.

11. The information handling system of claim 10 wherein the actions further comprise:
identifying one or more test environment elements that differ from the processing environment indicated by the selected problematic usage pattern;
retaining, in a data store, the identified test environment elements as possible usage pattern resolutions pertaining to the selected problematic usage pattern;
receiving, over the computer network, a subsequent error report from a user of one of the installed software systems in the user community;
generating a subsequent problematic usage pattern pertaining to the subsequent error report;
matching the subsequent problematic usage pattern to the selected problematic usage report;
retrieving the possible usage pattern resolutions from the data store; and
transmitting, over the computer network, the possible usage pattern resolutions to the user.

12. The information handling system of claim 8 wherein the actions further comprise:
receiving, over the computer network, a plurality of configuration reports from a plurality of successfully installed software systems in the user community, wherein each of the configuration reports include a plurality of configuration elements; and
generating a set of success-based usage patterns based on an analysis of the received configuration reports.

13. The information handling system of claim 12 wherein the actions further comprise:
receiving, over the computer network, a deployment request from a selected system in the user community that is commencing installation of the software system, wherein the deployment request includes one or more environment elements pertaining to the selected system;
comparing the environment elements that pertain to the selected system with the success-based usage patterns, the comparison resulting in a set of one or more of the success-based usage patterns that match the environment elements that pertain to the selected system; and
recommending one or more configuration parameter values as inputs to the installation of the software system on the selected system.

14. The information handling system of claim 13 wherein the actions further comprise:
recommending, based on the set of success-based usage patterns, one or more pre-requisite software programs, wherein the recommendation further includes a version corresponding to each of the pre-requisite software programs; and
displaying the recommended pre-requisite software programs and versions to a user of the selected system prior to installation of the software system.

15. A computer program product stored in a computer readable medium, comprising computer instructions that, when executed by an information handling system, causes the information handling system to perform actions comprising:
receiving, over a computer network, a plurality of error reports from a plurality of systems in a user community running a set of one or more software offerings that includes one or more sections of code;
generating a set of problematic usage patterns based on an analysis of the received error reports, wherein each of the usage patterns has a confidence factor;
increasing the confidence factors corresponding to a set of the problematic usage patterns in response to multiple received error reports matching the set of problematic usage patterns;
matching the problematic usage patterns to the one or more sections of code; and
identifying one of the sections of code based on the identified section of code matching a selected one of the problematic usage patterns and based on the selected problematic usage pattern having a confidence factor greater than a threshold.

16. The computer program product of claim 15 wherein the sections of code are included in a plurality of different software offerings, and wherein the plurality of different software offerings includes the set of software offerings.

17. The computer program product of claim 16 wherein the problematic usage patterns indicate a processing environment, and wherein the actions further comprise:
setting a test environment to the processing environment indicated by the selected problematic usage pattern;
testing the identified section of code in the test environment;
identifying the selected problematic usage pattern as a false positive in response to the testing failing to result in an error indicated by the selected problematic usage pattern; and
decreasing the confidence factor of the selected problematic usage pattern in response to the identification of the false positive.

18. The computer program product of claim 17 wherein the actions further comprise:
identifying one or more test environment elements that differ from the processing environment indicated by the selected problematic usage pattern;
retaining, in a data store, the identified test environment elements as possible usage pattern resolutions pertaining to the selected problematic usage pattern;
receiving, over the computer network, a subsequent error report from a user of one of the installed software systems in the user community;
generating a subsequent problematic usage pattern pertaining to the subsequent error report;
matching the subsequent problematic usage pattern to the selected problematic usage report;
retrieving the possible usage pattern resolutions from the data store; and
transmitting, over the computer network, the possible usage pattern resolutions to the user.

19. The computer program product of claim 15 wherein the actions further comprise:
receiving, over the computer network, a plurality of configuration reports from a plurality of successfully installed software systems in the user community, wherein each of the configuration reports include a plurality of configuration elements; and
generating a set of success-based usage patterns based on an analysis of the received configuration reports.

20. The computer program product of claim 19 wherein the actions further comprise:
receiving, over the computer network, a deployment request from a selected system in the user community that is commencing installation of the software system, wherein the deployment request includes one or more environment elements pertaining to the selected system;
comparing the environment elements that pertain to the selected system with the success-based usage patterns, the comparison resulting in a set of one or more of the success-based usage patterns that match the environment elements that pertain to the selected system;
recommending one or more configuration parameter values as inputs to the installation of the software system on the selected system;
recommending, based on the set of success-based usage patterns, one or more pre-requisite software programs, wherein the recommendation further includes a version corresponding to each of the pre-requisite software programs; and
displaying the recommended pre-requisite software programs and versions to a user of the selected system prior to installation of the software system.
